(19) United States
(12) Patent Application Publication
(10) Pub. No.: US 2006/0146271 A1
(43) Pub. Date: Jul. 6, 2006

(54) Universal display module

(76) Inventors: Thomas J. Pennaz, Champlin, MN (US); Adam Laubach, Plymouth, MN (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 11/029,201

(22) Filed: Jan. 4, 2005

(51) Int. Cl. C09K 19/02; G02F 1/1333

(52) U.S. Cl. 349/182; 349/58

(57) ABSTRACT

A universal display module is disclosed which includes a backplane, a top plane and an ink layer in contact with a pair of spaced apart electrodes to form a display and other optional components, such as a drive chip, a battery, a sensor, a logic chip, membrane switches, RFID antenna and a biometric sensor, that can be incorporated into a wide range of devices. Unlike other known display modules, the universal display module in accordance with the present invention is flexible enough to be used in labels, cards, vacuum formed parts, injection molded parts or other integration techniques, such as hot lamination without modifying the module. As such, universal display module in accordance with the present invention provides economies of scale by allowing for the production of a single robust display module that can be used for a variety of end uses and reduces inventories as well as production costs related to both the manufacturing as well as the integration of the display. As such, the module allows an integrator to use a wide range of common integration techniques, such as hot lamination, label insertion, vacuum forming, cold lamination and injection molding for integrating the display module into an end application. No known display technology exists today which can be used in such a wide range of manufacturing processes.

### BACKGROUND OF THE INVENTION

1. Field of the Invention

The present invention relates to a universal display module and more particularly to a display module that can be embedded into various end applications by a variety of integration techniques including hot lamination, label insertion, vacuum forming, cold lamination, injection molding and mechanical insertion.

2. Description of the Prior Art

Display modules are devices that are integrated or embedded into various end applications that are used to process and convey information to a user in a variety of applications, for example, smart cards, smart labels, phone handsets and the like. There are many known display technologies. These display technologies include liquid crystal displays (LCD), organic light-emitting diodes (OLED), electroluminescent (EL), field-emission display (FED), electrophoretic, electrochromic, and electronic paper. Many characteristics are considered when choosing a display technology for an end application including low power, resolution, thinness, form factor, and method of integration. While all these parameters are all important, it is often the method of integration that is most limiting. In many cases, the end application has been known to limit the method of display integration, which, in turn, limits the choice to a single technology or module.

More particularly, liquid crystal displays (LCDs) are commonly used in portable electronics, such as cell phones, laptop computers, and personal digital assistants (PDA's). An LCD consists of layers of liquid crystalline material sandwiched between two substrates in a cell of a specified thickness. The liquid crystalline material changes molecular alignment when a voltage is applied. As such, LCD's are known to contain alignment layers, conductive layers, polarization layers, and in some cases reflective layers forming a multi-layer stack. This multi-layer stack is commonly fabricated using a glass or silicon substrates resulting in a relatively rigid device. Unfortunately, such rigid display devices cannot easily be integrated into vacuum formed parts or injection molded parts. Moreover, such LCDs are also known to have intrinsic limitations. For example, LCDs require that a particular distance be maintained between the two substrates, known as “cell gap.” In addition, LCDs are known to be fragile and thus are not suitable for many applications. Even though LCDs are known which utilize plastic substrates, LCDs are still not suitable for some integration methods. Heat and pressure introduced by hot lamination integration methods, for example, in the fabrication of smart cards, may damage LCD.

Organic light-emitting diodes (OLED) are also known display devices. These OLEDs are known to target many of the same applications as LCDs. OLEDs consist of thin films of organic materials, sandwiched between two electrodes. When a bias is applied the electrodes, excitons are generated which emit light as they relax to the ground state. These display devices can be fabricated on various substrates including glass, silicon, and plastic. OLEDs formed with rigid substrates have the same integration based limitations as LCDs formed with rigid substrates. OLEDs formed with flexible substrates are known to be limited in application. In particular, the intrinsic instability of the OLED materials and the fragile nature of these devices prohibit integration of such OLEDs in many applications including injection molding and vacuum forming. Moreover, the materials used to form an OLED require the use of barrier layers to prevent oxygen and moisture from entering the device, thus making mechanical integrity difficult to maintain during these processes. In addition to these limitations, the thermal stability of materials used in OLED is low (<100° C.), thus limiting some integration techniques, such as hot lamination of the display module.

Electrophoretic displays consist of charged pigmented particles (i.e., ink) which are suspended in a liquid medium between two substrates, each of which are patterned with electrodes. The ink is printed onto one substrate that is laminated to another substrate formed with a layer of circuitry which, in turn, forms a pattern of pixels that is controlled by a display driver. Both glass and plastic are known to be used for substrates for such electrophoretic displays. The materials used in these display modules are not rugged or robust enough to withstand integration by vacuum forming, injection molding, or hot lamination.

Another problem with many known display technologies is the voltage requirements of the display itself. Some known displays technologies require 10-15 volts DC for proper operation and may require voltage or current conditioning in order to be integrated into certain end applications . Such displays thus require additional components and/or circuitry, making such displays relatively more expensive to integrate into end applications.

In addition to the voltage requirements, known display technologies are basically limited in application by the process used to integrate the display module into end application and are also limited by the end application itself. Thus, there is a need for a display device that can be integrated into an end application without be limited by the integration process or the end application.

### SUMMARY OF THE INVENTION

Briefly, the present invention relates to a universal display module which includes a backplane, an ink layer in contact with a pair of spaced apart electrodes and a top plane to form a display, and other optional components, such as a drive chip, a battery, a sensor, a logic chip, membrane switches, RFID antenna and a biometric sensor, that can be incorporated into a wide range of devices. Unlike other known display modules, the universal display module in accordance with the present invention is flexible and thin enough to be used in labels, cards, vacuum formed parts, injection molded parts or other integration techniques, such as hot lamination without modifying the module. Additionally, the displays of the present invention operate with relatively low direct current (DC) power requirements which further simplifies the integration of the module by eliminating the need for additional circuitry such as inverters or voltage multipliers to provide the higher voltages or alternating current (AC) required by many other display technologies. As such, universal display module in accordance with the present invention provides economies of scale by allowing for the production of a single robust display module that can be used for a variety of end applications and reduces inventories as well as production costs related to both the manufacturing as well as the integration of the display. Accordingly, the universal display module allows an integrator to use a wide range of common integration techniques, such as hot lamination, label insertion, vacuum forming, cold lamination and injection molding for integrating the display module into an end application. No known display technology can be used in such a wide range of manufacturing processes, operate at such low power requirements and provide the thin form factor of the present invention.

### DESCRIPTION OF THE DRAWING

These and other advantages of the present invention will be readily understood with reference to the following specification and attached drawing wherein:

FIG. 1 is a front elevational view in section of the universal display module in accordance with the present invention.

FIG. 2 is an exemplary process diagram which illustrates the steps involved in making a universal display module illustrated in FIG. 1.

### DETAILED DESCRIPTION

The present invention relates to a universal display module that can be used in a relatively wide variety of applications, such as consumer portable electronics, smart cards, smart labels, test and measurement equipment, signage, and wearable electronics. The universal display module is capable of displaying alpha-numeric, iconic, or graphical information or any combination thereof. In accordance with an important aspect of the invention, the universal display module can be integrated in various end applications by way of a variety of manufacturing and integration methods including hot lamination, label insertion, vacuum forming, cold lamination, injection molding and mechanical insertion.

In order to accommodate various end applications, the universal display module is formed from materials that enable it to be flexible and robust enough to be integrated into labels, cards, vacuum-formed parts, or injection molded parts via implied integration techniques without modifying the module. The universal display module is also stable and robust enough to withstand the pressure of lamination, and associated heat of hot lamination techniques. In accordance with an important aspect of the invention, the universal display module is formed with non-aqueous ink or other ink that can withstand the temperature associated with hot lamination integration methods (hereinafter “non-volatile ink”). Examples of such non-volatile ink are disclosed in U.S. Pat. Nos. Nos. 6,639,709 and 6,744,549 and U.S. patent application Ser. No. 10/102,236, filed on Mar. 19, 2002, published as US Patent Publication No. US 2002/0171081 A1, published on Nov. 21, 2002, all assigned to the assignee of the present invention and hereby incorporated by reference. As such, the universal display module is not affected by the integration technique or the end application.

The use of the non-volatile ink, as discussed above, enables the displays of the present invention to operate at voltages as low as 1.2 volts DC. This allows the use of traditional battery technology, such as carbon zinc or lithium cells, without the addition of components to modify the voltage or current in order to operate the display. The universal display module of the present invention consumes relatively low power, typically less than 500 microamps per pixel, which allows smaller batteries for a particular application and improves the ease of integration. As such, a thinner layer of dielectric can be used, thus making the display and thus the universal display module relatively more flexible than known display modules.

The universal display module in accordance with the present invention includes a backplane substrate, a front plane substrate and a display, an optional drive chip and other optional components, such as a battery, sensor, logic chip, membrane switches, RFID antenna and biometric sensor. The universal display module may be formed with all electrical circuitry necessary required for the components as well as a backplane for the display. It may be produced by various known manufacturing techniques including traditional screen printing, flexographic printing, or gravure printing. Traditional flexible circuit methods, such as copper etching, foil stamping or patterned sputtering may also be employed. Techniques are also known which utilize ink jet and other methods to form the conductive traces necessary for the backplane. All such manufacturing techniques are considered to be within the broad scope of the invention. The method for production of the backplane is normally dictated by the resolution required for the circuitry and cost.

The backplane is formed on the backplane substrate with a number of display pixels and associated electrical connection points for connection to other optional elements, such as IC chips, switches or a battery. If an antenna is employed, the connection points for an IC or the display pixels are open. Substrates suitable for a backplane include a wide range of known substrate materials. For example, traditional films, such as polyester, polyimides, polypropylene, polycarbonate or polyvinylchloride may be employed. The backplane substrate may also be constructed on paper and paperboard substrates, as well as rigid substrates, such as foils or metals, if suitable electrical insulation is provided for the circuit. Normally, the choice of substrate for the backplane is dictated by the end application, ease of processing and subsequent assembly steps such as die attach.

Once the circuitry has been formed on the backplane substrate, a dielectric coating is applied to insulate all traces of the circuitry except in areas where additional electrical connections are required and where the display pixels are located. The purpose of the dielectric is to protect the circuits and prevent electrical shorting with other conductive elements in the module. In the display area, the dielectric prevents undesired elements from imaging. The dielectric can applied be tradition print methods as well as photo mask techniques, all well known in the art. Suitable dielectric materials include Acheson Electrodag 1020A at a typical print thickness of 5-20 microns. Typical solder masks used in flexible copper etch circuits may also be employed. The desired resolution, technique used to form the circuitry, as well as the cost normally dictate which process is used to deposit the dielectric layer.

The display is constructed by depositing a non-volatile electro-active ink in the display area in contact with a pair of spaced apart electrodes. The electrodes may be formed on different substrates or side by side on the same substrate. Such displays operate by applying a voltage potential across the electrodes. The applied voltage causes current to flow across the ink, which, in turn results in illumination or “imaging” of the ink. The non-volatile ink described above is known to image at about 1.2 volts DC without the need for any voltage or current conditioning components or circuitry.

The non-volatile electro-active ink may be deposited by tradition screen, stencil or flexographic printing techniques. The non-volatile electro-active ink may be deposited as a block of ink covering the entire display area or may be printed as a pattern directly over the conductive pixels. The preferred method is normally determined by the desired thickness of this ink layer. Exemplary thicknesses for the non-volatile electro-active range from about 5 microns up to a thickness of about 250 microns. Stencil printing is known to result in the thickest deposit, followed by screen printing. Flexographic and gravure printing are known to result in the thinnest layer of ink.

The top plane may be produced by utilizing a transparent conductive film, such as, polyester sputtered indium tin oxide (ITO), to form an electrode. The top plane can be of uniform conductivity or may be patterned to define specific pixels. The patterning can be obtained by printing a clear dielectric in specific areas or by methods such as chemical or laser etching which selectively removes areas of the sputtered ITO coating. Alternatively, clear conductive traces can be produced by utilizing a clear conductive ink such as ITO inks, antimony tin oxide (ATO) inks which are known in the art. The top plane may only cover the display area of the module although it could be used, for example, as the shorting layer of a membrane switch, or provide additional electrical functionality, if desired.

An adhesive gasket may be formed to seal the edges of the display and to anchor the top plane to the backplane. A variety of techniques may be employed to form the gasket including printing a heat seal, UV curable pressure sensitive or die cutting and laminating a pressure sensitive tape. The adhesive properties necessary to practice the invention include a sufficient adhesion to hold the assembly together as well as be non-reactive to the electro-active inks. The thickness of the sealing gasket may be determined by the thickness of the electro-active ink layer. The gasket must be the same thickness as, or thinner than, that of the electro-active ink layer to insure constant electrical connection between the top plane and the backplane.

The top plane may be produced as a separate substrate and then laminated, in-line with the backplane. The backplane contains the entire module circuit including at least one electrode while the front plane contains at least one electrode. Those skilled in the art will recognize that alternatively the electro-active can be printed on the front plane and the gasket adhesive printed on the backplane if desired. The only restriction is that the adhesive and electro-active inks must be deposited on opposite layers.

The final step in fabricating the universal display module assembly includes the electrical connection of the front plane to the backplane. This is accomplished by attaching the front plane to the backplane using a conductive adhesive, such as screen printing a conductive epoxy or using a conductive pressure sensitive tape.

After the step, mentioned above, the module which contains the display is ready for additional component placement and attachment including placement of optional devices, such as an IC domed switches and a battery or other components. Methods employed in subsequent steps utilize traditional pick and place techniques to juxtapose the optional component to the universal display module, all well known in the art. A variety of electrical connection techniques known in the art may be employed to attach auxiliary components. These electrical connection techniques include, for example, flip chip attach, wire bonding, solder or anisotropic pressure sensitive adhesives.

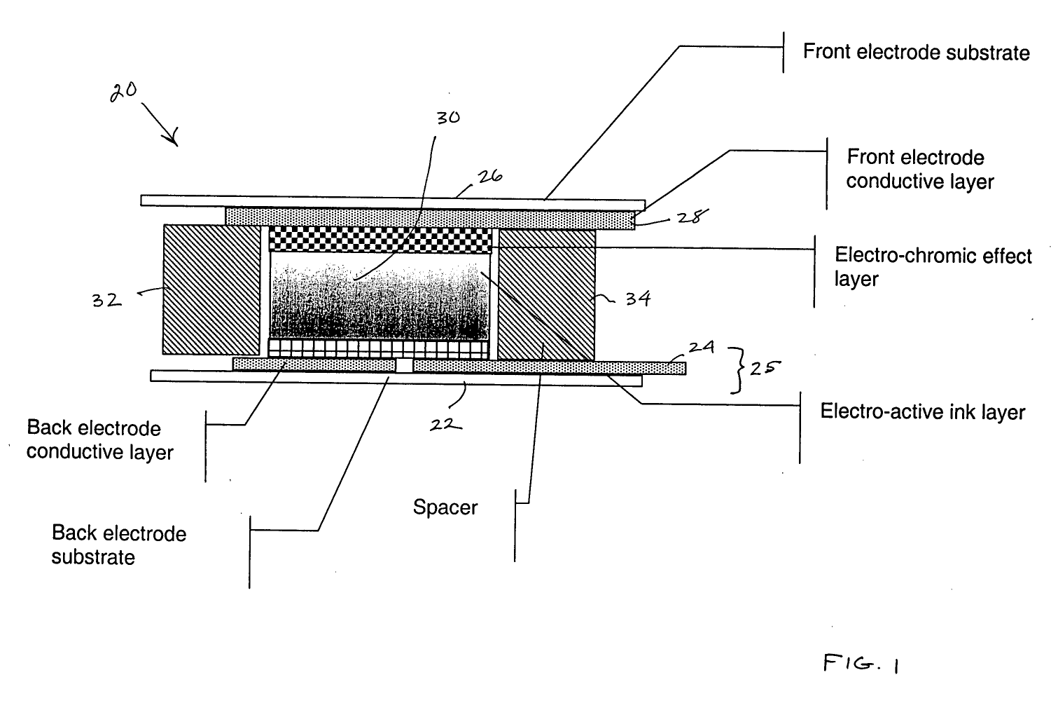

An exemplary universal display module is illustrated in FIG. 1 and generally identified with the reference numeral 20. The universal display module 20 includes a backplane substrate 22, patterned with backplane circuitry, generally identified with the reference numeral 24, which may include at least one electrode, an electrically conductive and transparent top plane substrate 26, a top plane conductive layer 28 which may include at least one electrode, a display 30 and a pair of spacers 32 and 34. Alternatively, the electrodes may be formed in a spaced part side by side relationship on either the top plane or the backplane. As discussed above, the universal display module 20 also includes an adhesive gasket (not shown), for sealing the top plane 26 to the backplane 24. The top plane 26 and backplane 24 are also shorted together, for example, with a conductive epoxy (not shown).

Many different configurations are contemplated for the shorting conductors 32, 34. For example, pressure sensitive conductive adhesives or conductive tapes may be employed can be used. Suitable adhesive for this purpose is available from Emerson and Cummings under the part number XCE-3014. Alternatively, a conductive adhesive, such as silver epoxy, may be screen printed or needle dispensed to form the gasket or provide the electrical connection. Suitable conductive epoxies include Acheson Electrodag 5810 for this purpose. All such embodiments are considered to be within the broad scope of the invention.

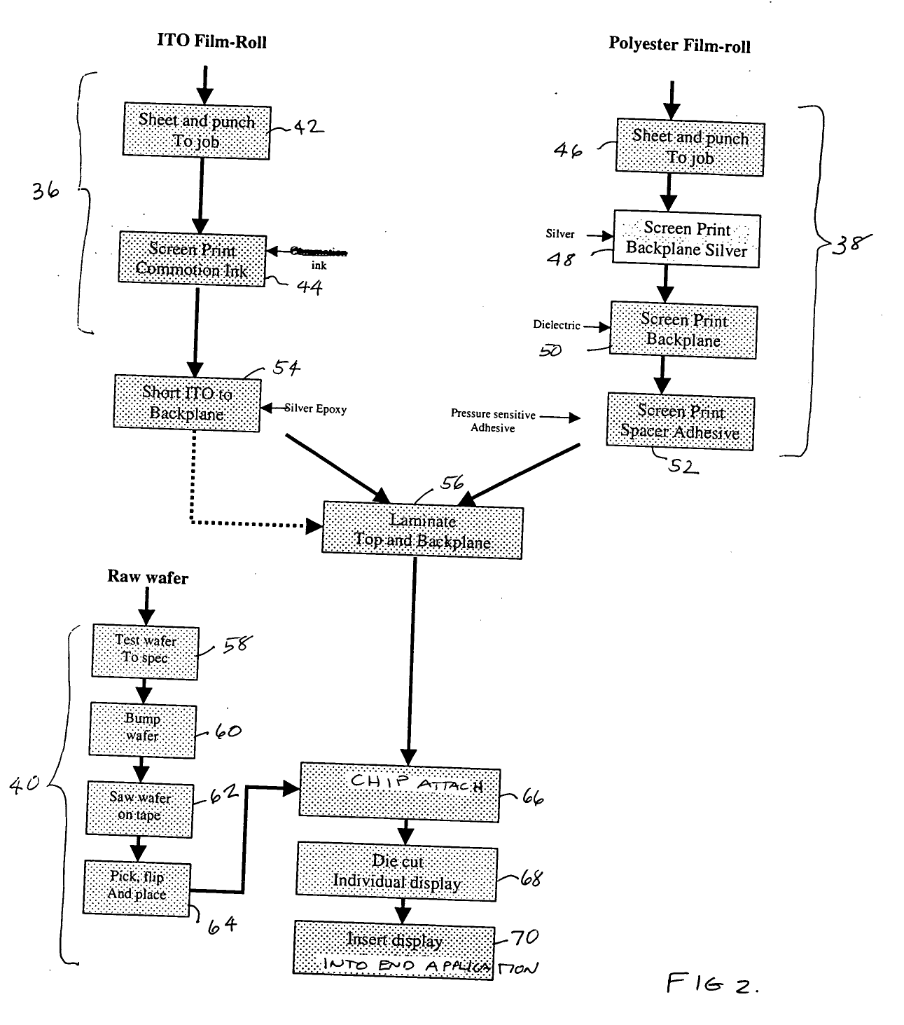

An exemplary process diagram for making a universal display module 20 in accordance with the present invention is illustrated in FIG. 2. The left leg of the process diagram, generally identified with the reference numeral 36, relates to fabrication of the top plane 26 (FIG. 1) while the right leg of the diagram, generally identified with the reference numeral 38, relates to the fabrication of the backplane 24 . The bottom left leg of the process diagram, generally identified with the reference numeral 40, illustrates exemplary additional process steps involved in order to add optional components to the universal display module 20.

Referring first to the process 36 for fabricating the top plane 26, initially a roll of a transparent conductive film is provided. Various transparent conductive films are suitable for this purpose, such as polyester sputtered indium tin oxide (ITO). Rolls of ITO film are available from various sources, including Sheldahl, part number 155597-xxx which has a nominal resistance of 60 ohms per square. Initially, in step 42, the film is optionally cut into sheets and punched in accordance with the application. In step 44, the non-volatile ink is screen printed on the top plane 26, for example, to form a rectangular block.

The backplane, generally identified with the reference numeral 25, consists of the backplane substrate 22 and the circuitry 24 printed thereupon. The backplane 25 is processed by the process 38 and may be formed from several different methods. As shown, a roll of polyester film is provided. Such polyester film is available from various sources, such as Dupont under the tradename Melinex, part number is ST-506. The polyester film is cut into sheets and punched per the job specification, as set forth in step 46. The polyester film is used for the backplane substrate 22. The circuitry 24, formed on the backplane substrate 22, may be formed by screen printing silver on the backplane substrate 22, as shown in step 48. In order to prevent unwanted imaging of electrodes and other devices in the circuitry, a dielectric is screen printed on the backplane 24 in step 50. In the embodiment shown, a pressure sensitive adhesive is screen printed in step 52 to provide a spacer between the backplane 22 and the top plane 26. After the backplane 25 is fabricated, the backplane 25 is registered with the top plane 26 and shorted thereto as illustrated in step 54, for example, by a conductive epoxy. Subsequently, the top plane 26 and backplane 25 are laminated together as generally illustrated in step 56.

Optional components may be added to the universal display module 26 by the process 48. In the exemplary embodiment, the optional integrated circuits (IC) and other devices may be provided in the form of wafers. Initially, in step 58, the wafers may be tested to ensure that they meet the specifications. Subsequently, in step 60, silver bumps are formed on the connection pads of the wafer to facilitate connection of the optional component to the universal display module subassembly. In step 62, the wafers are sawed into a number of individual components, known as die, in step 62. In step 64, the die are juxtaposed to the universal display module subassembly and attached thereto in step 66. The individual display modules, formed on the sheet, are then die cut in step 68 to form individual universal display modules 20. The universal display modules 70 are then placed or inserted into their end applications.

An alternate process for forming the universal display module 20 which utilizes a copper etch backplane 25 is described below. Initially, a 2 mil polyimide substrate, such as Kapton, with 0.5 ounce copper foil may be chemically etched to produce a backplane circuit 24. The backplane circuit 24 may include a seven segment display and electrical connections for a display drive chip and contain the circuitry for domed membrane switches and a printed battery. Subsequently, a photo-masked dielectric may be applied to the backplane circuit 24 to cover all traces except in the connection points for the drive chip, switches and battery. The pixel areas for the display also are non-insulated. Using a rotary screen printing press, sputtered ITO with a conductive pressure sensitive adhesive is patterned to form the gasket as discussed above. The adhesive can be protected from contamination by applying a silicone release liner over the exposed adhesive. The backplane is then printed with non-volatile electro-active ink to form the active display. The pre-formed front plane 26 is laminated to the backplane 25. The front plane 26 must be laminated in registration to insure the pressure sensitive gasket and the electro-active ink match. The module then moves through a traditional pick and place line to attach the drive chip, place the domes for the switches and place the battery as discussed above. The module is now ready for subsequent integration into finished products using a variety of manufacturing techniques. For example, the module can be hot laminated into a smart card or traditional credit card. It can be cold-laminated into a card or label format. The same module could be vacuum formed into a cell phone chassis.

Obviously, many modifications and various of the present invention are possible in light of the above teachings. Thus, it is to be understood that, within the scope of the appended claims, the invention may be practiced otherwise than is specifically described above.

What is claimed and desired to be secured by a Letters Patent of the United States is:

1. A universal display module comprising:
a backplane formed with a substrate;
a top plane formed with a conductive transparent substrate;
a pair of spaced apart electrodes; and
a non-volatile ink sandwiched between said backplane and said top plane in contact with said pair of electrodes; and
a conductive adhesive for shorting and securing said top plane to said backplane.

2. The universal display module as recited in claim 1, wherein said pair of electrodes are formed in a side by side relationship on or the other of said top plane or said backplane.

3. The universal display module as recited in claim 1, wherein said pair of electrodes define a first electrode and a second electrode, said first electrode formed on said top plane and said second electrode formed on said backplane.

4. The universal display module as recited in claim 1, wherein the conductive transparent substrate is a transparent conductive film.

5. The universal display module as recited in claim 4, wherein said transparent conductive film is polyester sputtered indium tin oxide (ITO).

6. The universal display module as recited in claim 1, wherein said top plane is formed from a uniform sheet of material.

7. The universal display module as recited in claim 1, wherein said top plane is patterned.

8. The universal display module as recited in claim 1, wherein said backplane substrate is formed from a copper foil.

9. The universal display module as received in claim 1, wherein said substrate for said backplane is formed from a film formed from polyester.

10. The universal display module as received in claim 1, wherein said substrate for said backplane is formed from a film formed from polyimide.

11. The universal display module as received in claim 1, wherein said substrate for said backplane is formed from a film formed from polypropylene.

12. The universal display module as received in claim 1, wherein said substrate for said backplane is formed from a film formed from polycarbonate.

13. The universal display module as received in claim 1, wherein said substrate for said backplane is formed from a film formed from polyvinylchloride.

14. The universal display module as recited in claim 1, wherein said substrate for said backplane is formed from paper.

15. The universal display module as recited in claim 1, wherein said substrate for said backplane is formed from paperboard.

16. The universal display module as recited in claim 1, further including a drive circuit.

17. The universal display module as recited in claim 1, further including one or more optional components.

18. The universal display module as recited in claim 17, wherein said one or more optional components include an integrated circuit.

19. The universal display module as recited in claim 17, wherein said one or more optional components include one or more switches.

20. The universal display module as recited in claim 17, wherein said one or more optional components include one or more sensors.

21. The universal display module as recited in claim 17, wherein said one or more optional components include one or more antennas.

22. The universal display module as recited in claim 17, wherein said one or more optional components include one or more batteries.

23. A method of making a universal display module comprising the steps of
(a) forming a top plane from a transparent conductive substrate;
(b) forming a first electrode;
(c) forming a backplane from a substrate;
(d) forming a second electrode;
(e) sandwiching a non-volatile ink between said top plane and said backplane in contact with said first and second electrodes; and
(f) securing and electrically shorting said top plane to said backplane.

24. The method as recited in claim 23 further including a step (g) of: attaching an optional component to said at least one electrode.
